(19) United States
(12) Patent Application Publication
(10) Pub. No.: US 2023/0247025 A1
(43) Pub. Date: Aug. 3, 2023

(54) INFORMATION PROCESSING DEVICE, METHOD, AND NON-TRANSITORY COMPUTER-READABLE RECORDING MEDIUM THEREFOR

(71) Applicant: Brother Kogyo Kabushiki Kaisha, Nagoya (JP)

(72) Inventor: Tomofumi NAKAYAMA, Tokoname (JP)

(73) Assignee: Brother Kogyo Kabushiki Kaisha, Nagoya (JP)

(21) Appl. No.: 18/152,210

(22) Filed: Jan. 10, 2023

(30) Foreign Application Priority Data
Jan. 31, 2022 (JP) 2022-013806

(51) Int. Cl. H04L 9/40

(52) U.S. Cl. CPC H04L 63/102; H04L 63/0807

(57) ABSTRACT

An information processing device comprises a controller. The controller is configured to perform obtaining a usage request to use a service using a particular device based on an input from a user, obtaining device identification information identifying the particular device, first obtaining including displaying, according to the usage request, a first input screen where account information is to be input when an associated account associated with the device identification information is not registered, and not displaying the first input screen when the associated account is registered, and registering the associated account in association with the device identification information based on the account information input on the first input screen when the associated account is not registered.

### REFERENCE TO RELATED APPLICATIONS

This application claims priority from Japanese Patent Application No. 2022-013806 filed on Jan. 31, 2022. The entire content of the priority application is incorporated herein by reference.

### BACKGROUND ART

The present disclosures relate to an information processing device configured to use services with particular devices, an information processing method, and a non-transitory computer-readable recording medium storing a computer program realized by computer-executable instructions.

There is known an image processing server which is configured to provide a user of a personal computer (hereinafter, referred to as PC) with a printing service. For example, the image processing server is configured to generate print data using an image file transmitted from the PC and transmits the generated print data to an MFP (multifunction peripheral) to make the MFP perform printing. The user has an account to log in to the image processing server for using such a printing service.

### DESCRIPTION

According to aspects of the present disclosure, there is provided an information processing device having a controller. The controller is configured to perform obtaining a usage request based on an input from a user, the usage request being a request of the user to use a service using a particular device, obtaining device identification information identifying the particular device, first obtaining including displaying, according to the usage request, a first input screen where account information is to be input when an associated account associated with the device identification information is not registered, and not displaying the first input screen when the associated account is registered, and registering the associated account in association with the device identification information based on the account information input on the first input screen when the associated account is not registered.

According to aspects of the present disclosure, there is provided a non-transitory computer-readable storage medium for an information processing device having a controller. The non-transitory computer-readable storage medium containing computer-executable instructions which cause, when executed by the controller, the information processing device to perform obtaining a usage request based on an input from a user, the usage request being a request of the user to use a service using a particular device, obtaining device identification information identifying the particular device, first obtaining including displaying, according to the usage request, a first input screen where account information is to be input when an associated account associated with the device identification information is not registered, and not displaying the first input screen when the associated account is registered, and registering the associated account in association with the device identification information based on the account information input on the first input screen when the associated account is not registered.

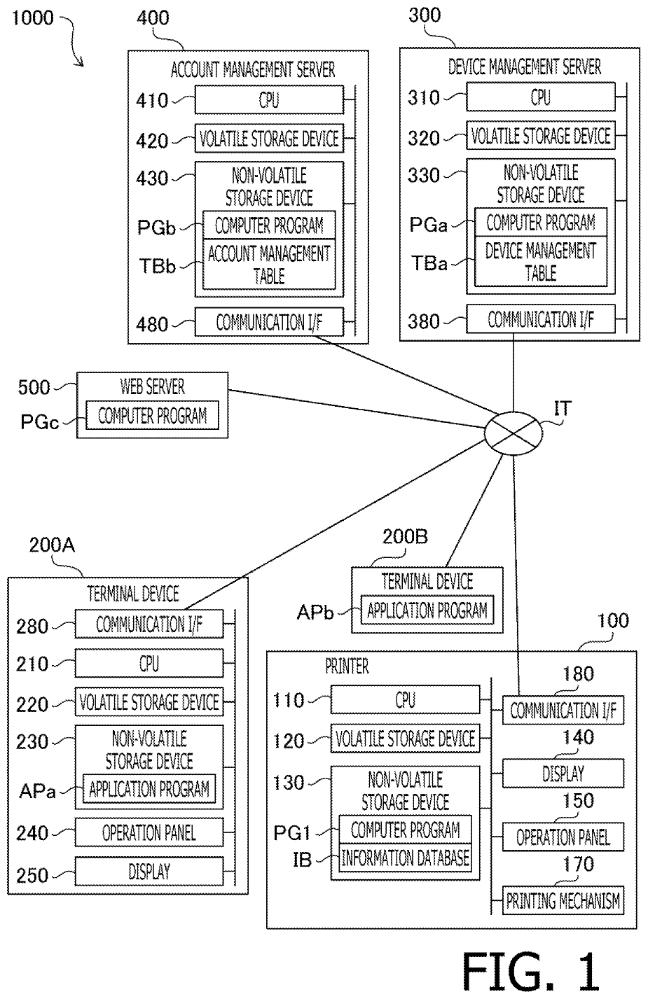

FIG. 1 is a block diagram showing a configuration of an information processing system.

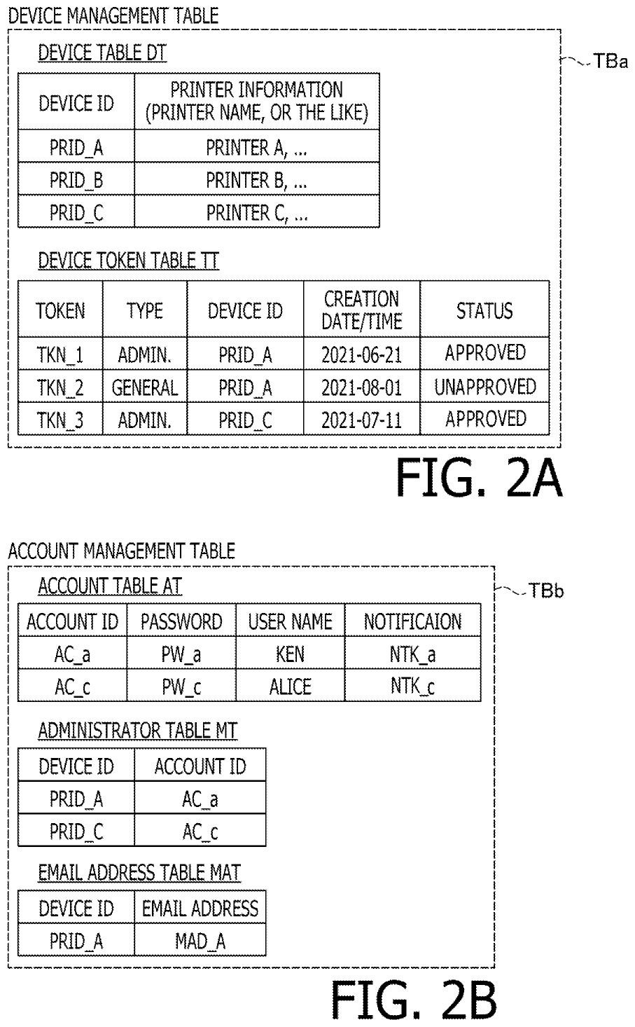

FIGS. 2A and 2B show examples of a table.

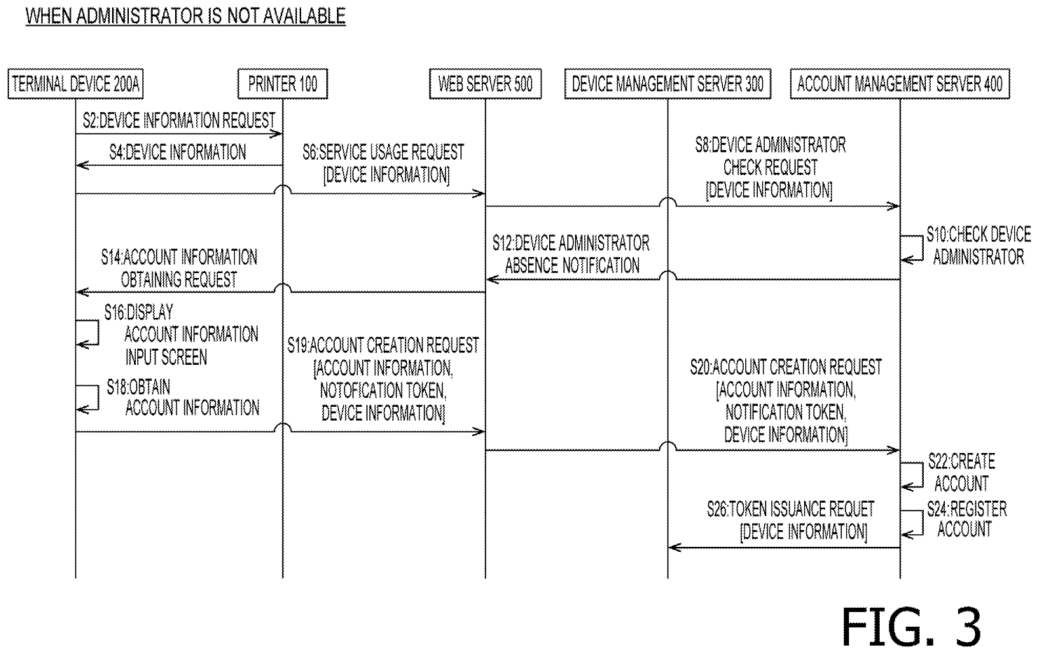

FIG. 3 is a first part of a sequence diagram illustrating a usage starting process when an administrator is not available.

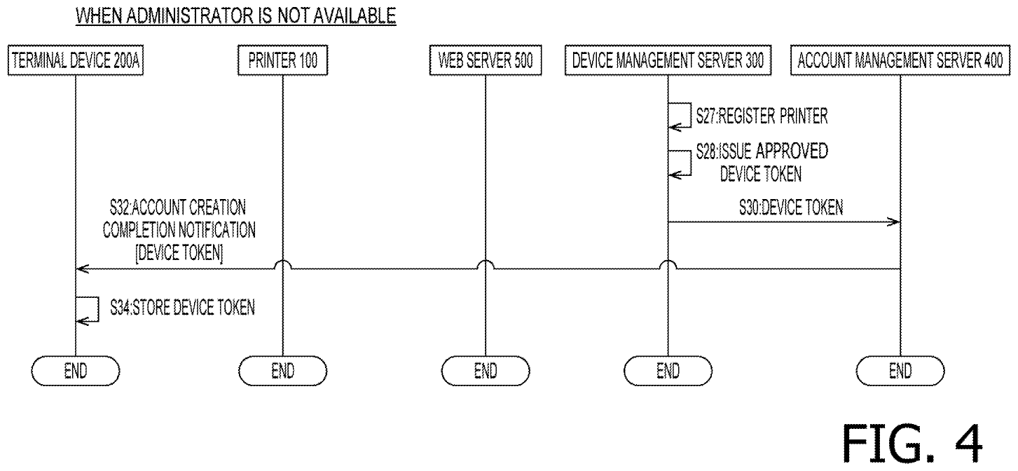

FIG. 4 is a second part of the sequence diagram illustrating the usage starting process when the administrator is not available.

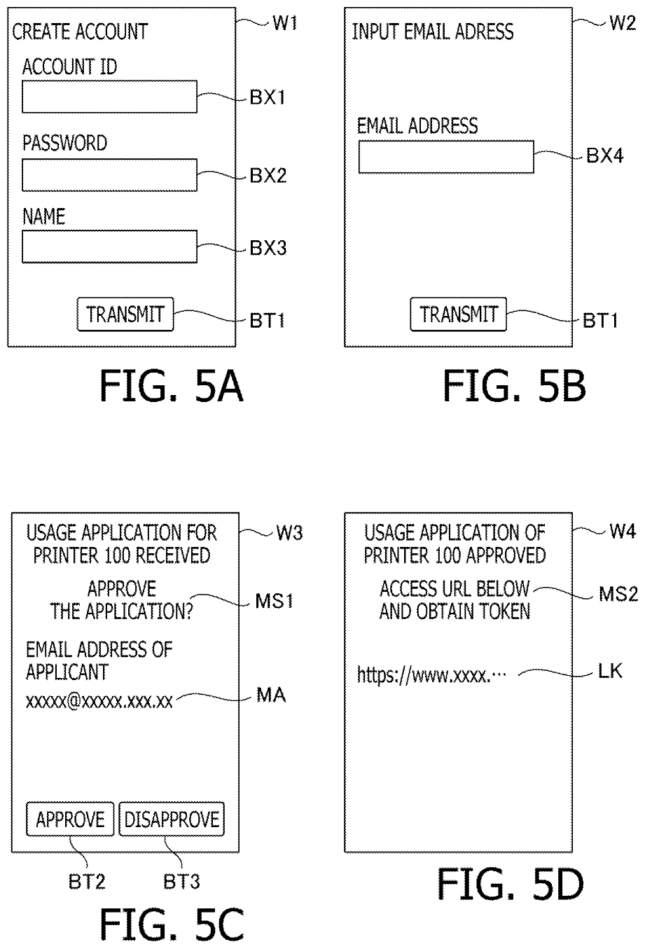

FIGS. 5A, 5B, 5C and 5D show examples of a screen displayed on a terminal device.

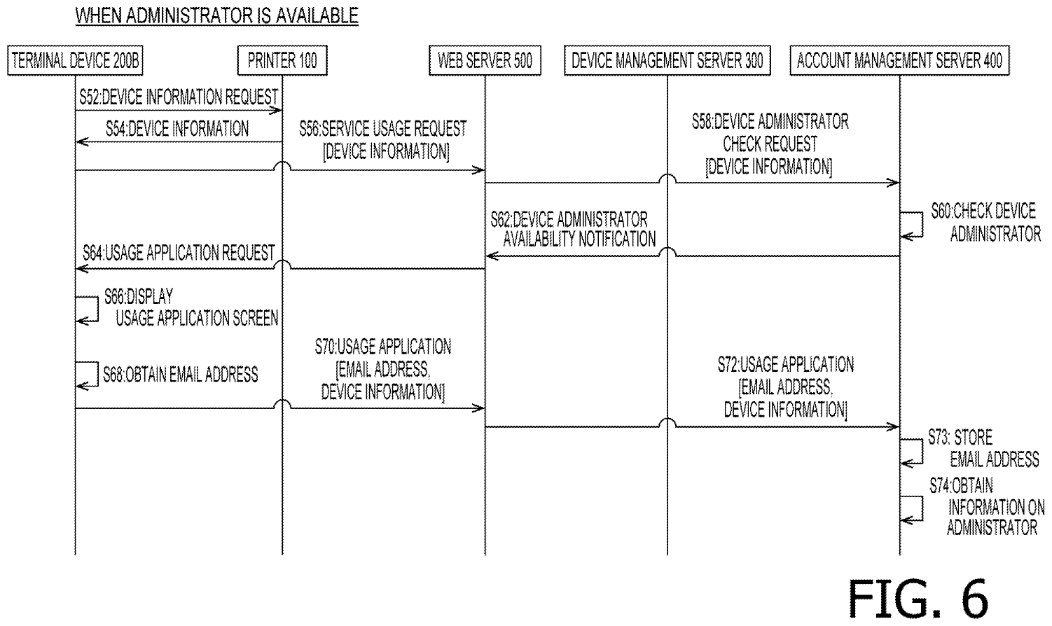

FIG. 6 is a first part of another sequence diagram illustrating a usage starting process when the administrator is available.

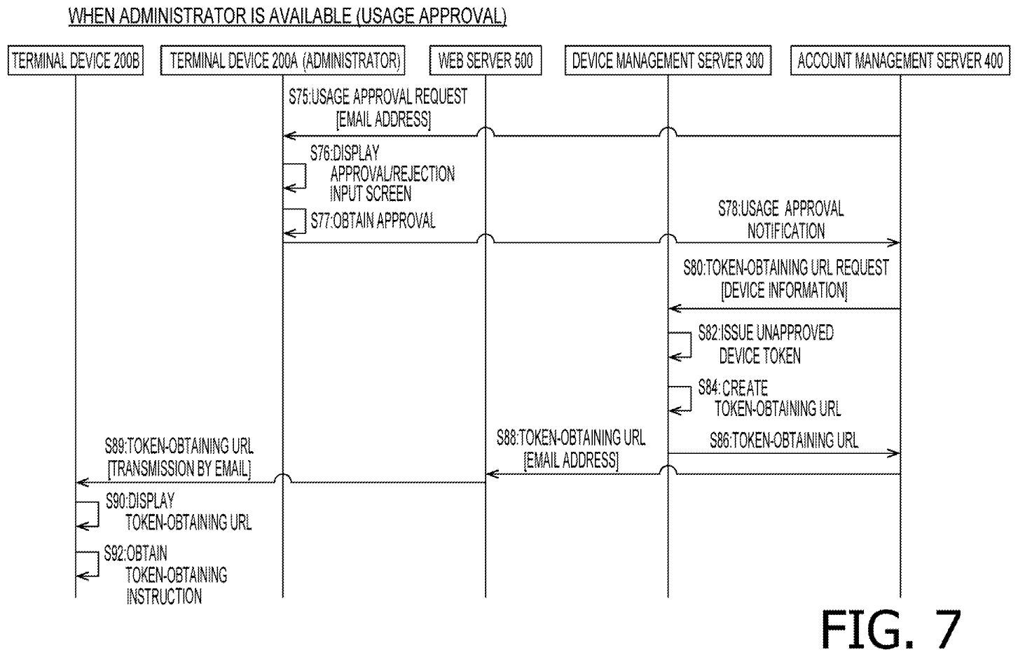

FIG. 7 is a second part of the sequence diagram illustrating the usage starting process when the administrator is available.

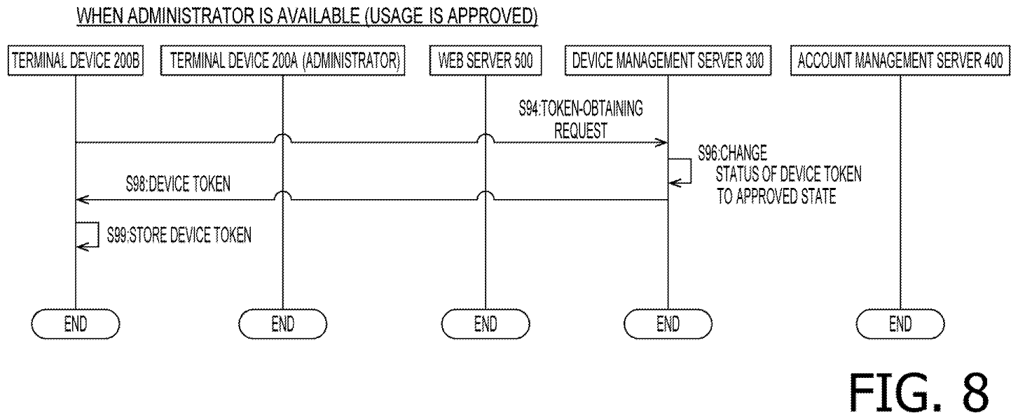

FIG. 8 is a third part of the sequence diagram illustrating the usage starting process when the administrator is available.

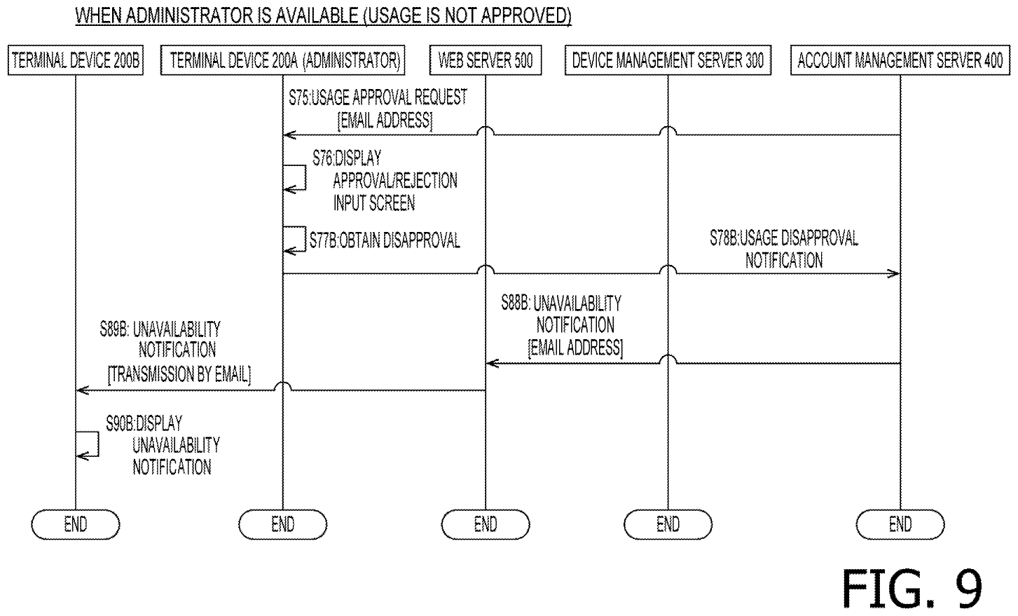

FIG. 9 is a fourth part of the sequence diagram illustrating the usage starting process when the administrator is available.

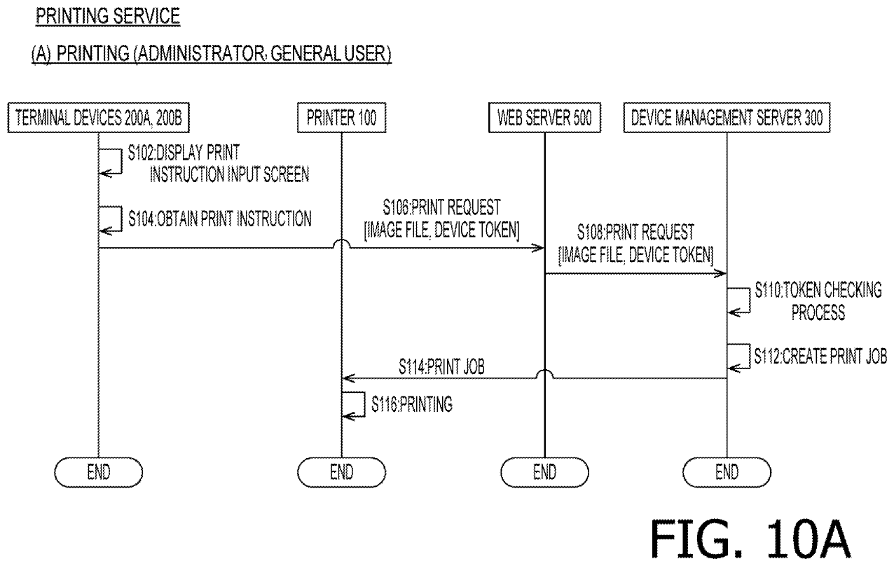

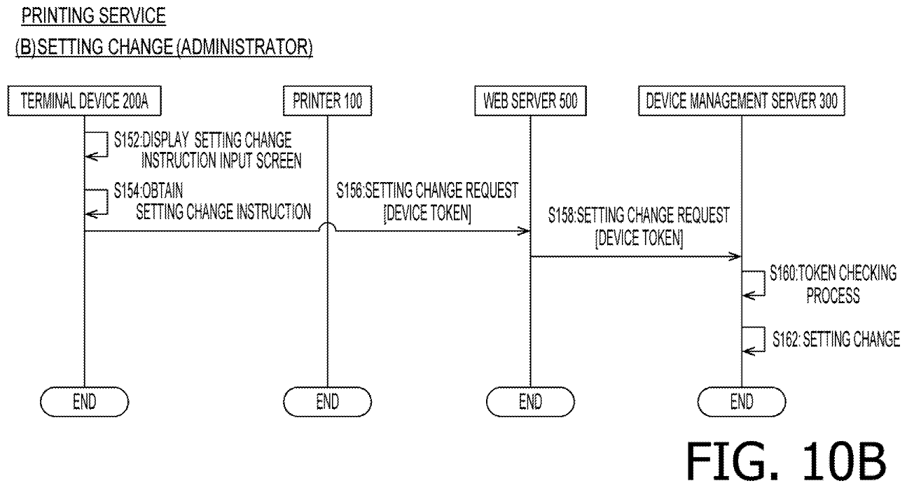

FIGS. 10A and 10B are sequence diagrams illustrating a printing service.

(1) CONFIGURATION OF INFORMATION PROCESSING SYSTEM

FIG. 1 is a block diagram illustrating a configuration of an information processing system (hereinafter, simply referred to as a system) 1000 according to aspects of the present disclosures. The system 1000 includes a printer 100, terminal devices 200A and 200B owned by a user of the printer 100, a device management server 300, an account management server 400 and a web server 500.

The printer 100 has, as a controller of the printer 100, a CPU 110, a volatile storage device 120 such as a DRAM, and a non-volatile storage device 130 such as a hard disk, a flash memory, and the like. The printer 100 further has a display 140 such as an LCD, an operation panel 150 provided with buttons, a touchscreen panel and the like for acquiring user's operations, a printing mechanism 170 and a communication I/F (interface) 180.

The communication I/F 180 is an interface to connect to the Internet IT. For example, the communication I/F 180 is a wired interface compliant with Ethernet (registered trademark of FUJIFILM Business Innovation Corp.) or a wireless interface compliant with standards of Wi-Fi (registered trademark of Wi-Fi Alliance).

The CPU 110 is an arithmetic device (processor) that performs data processing. The volatile storage device 120 provides a buffer area in which various intermediate data generated when the CPU 110 performs various processes is temporarily stored. In the non-volatile storage device 130, a computer program PG1 configured to control the printer 100 and information database IB in which various information such as device information and the like are to be stored.

In the present embodiment, the computer program PG1 is provided such that it has been pre-stored in the non-volatile storage device 130 at the time of manufacture of the printer 100. Alternatively, the computer program PG1 may be provided, for example, in the form of a download from a server connected via the Internet IT, or recorded on a CD-ROM or the like.

The CPU 110 control an overall operation of the printer 100 by executing the computer program PG1. For example, as will be described later, the CPU 110 provides a printing service to the users in association with the device management server 300. Concretely, when receiving a print job from the device management server 300, the CPU 110 controls the printing mechanism 170 to print images according to the print job. In addition, as will be described later, in response to a request from the terminal device 200A or 200B, the CPU 110 transmits device information such as device IDs to the requesting terminal device.

The printing mechanism 170 performs the printing in accordance with the control by the CPU 110. The printing mechanism 170 in this example is an inkjet printing mechanism configured to print an image on a printing medium using multiple types of ink (e.g., four types of ink: cyan, magenta, yellow, and black) as color materials. Alternatively, the printing mechanism 170 may be an electrophotographic printing mechanism configured to print an image on a recording medium using toner as the color material.

The terminal devices 200A and 200B are computers, which are, for example, smartphones. In a modified embodiment, the terminal devices 200A and 200B may be personal computers or tablet computers.

The terminal device 200A has, as a controller, a CPU 210, a volatile storage device 220 such as a DRAM and a non-volatile storage device 230 such as a hard disk or flash memory. The terminal device 200A has a display 250, such as an LCD, an operation panel 240 such as buttons and a touch panel for acquiring operations by the user, and a communication I/F 280. The communication I/F is, for example, a wireless communication interface compliant with Wi-Fi standards or mobile communication standards (e.g., LTE standards).

The volatile storage device 220 provides a buffer area to temporarily store various intermediate data that is generated by the CPU 210 when the CPU 210 performs processing. The non-volatile storage device 230 stores an application program AP.

The application program AP causes the CPU 210 of the terminal device 200A to perform various processes related to printing services, such as sending service usage requests to the account management server 400 and sending print requests to the device management server 300, as will be described later. For example, the application program AP is provided by a printing service provider (e.g., a business that manufactures or sells the printer 100). The application program AP is provided, for example, in the form of a download from a server connected via the Internet IT. Alternatively, the application program AP may be provided in the form of pre-installed on the terminal device 200A.

The terminal device 200B has the same configurations 210-280 (not shown) as the terminal device 200A. In FIG. 1, the configurations 210-280 are omitted and only the application program AP, which is stored in the non-volatile storage device 230, is illustrated. Hereafter, the functions realized by the CPU 210 of the terminal devices 200A and 200B by executing application programs AP will occasionally be referred to as “terminal applications.”

The device management server 300, the account management server 4000, and the web server 500 are, for example, cloud servers, and realized by computers operated by printing service providers. These servers cooperate to perform processes related to the printing services described below.

The device management server 300 has, as a controller, a CPU 310, a volatile storage device 320 such as DRAM, a non-volatile storage device 330 such as a hard disk or flash memory, and a communication I/F 380. The communication I/F 380 is, for example, a wired interface compliant with Ethernet.

The CPU 310 is an arithmetic device (processor) that performs data processing. The volatile storage device 320 provides a buffer area to temporarily store various intermediate data generated by the CPU 310 during processing. The non-volatile storage device 330 stores a computer program PGa and a device management table TBa, which will be described later.

The account management server, like the device management server, has, as a controller, a CPU 410, a volatile storage device 420, and a communication I/F 480. The volatile storage device 420 provides a buffer area to temporarily store various intermediate data generated by the CPU 410 during processing. The non-volatile storage device 430 contains a computer program PGb and an account management table TBb, which will be described later.

The Web server 500, like the device management server 300, has a well-known CPU, a volatile storage device and a non-volatile storage device, and a communication I/F. A computer program PGc is stored in the non-volatile storage device of the Web server 500.

The computer programs PGa, PGb, and PGc of these servers are provided, for example, in the form of uploaded by an operator of the printing service. The CPUs of the servers 300, 400, and 500 execute processes related to printing services by executing the computer programs PGa, PGb, and PGc, respectively. For example, the device management server 300 mainly manages information related to the printer to be managed, such as the printer 100, and generates and transmits print jobs. The account management server 400 mainly manages information related to the user (account information, email addresses, and other information as described below). The Web server 500 mainly executes communication with terminal applications executed on the terminal devices 200A and 200B.

These servers 300, 400, and 500 are communicably connected to each other via the Internet IT. The entirety of servers 300, 400, and 500 can be said to be one server for providing the printing service.

These servers 300, 400, and 500 can communicate with the printer 100 and terminal devices 200A and 200B via the Internet IT. The printer 100 and the terminal devices 200A and 200B can communicate with each other via the Internet IT or a well-known local area network.

Although only one printer 100 and two terminal devices 200A and 200B are illustrated in FIG. 1, the device management server 300 provides printing services to multiple users using multiple printers. In the following, various processes are described for printing services for one printer 100 and its users' terminal devices 200A and 200B. These processes are executed independently for each printer and each user's terminal device to be managed.

FIGS. 2A and 2B show examples of a table. As shown in FIG. 2A, the device management table TBa includes a device table DT and a device token table TT.

The device table DT is a table in which device information is to be recorded. The device information includes a device ID, a name of a printer to which the device ID is assigned, and printer information including a model number of the printer. In the device table DT, the device ID of a management target printer (e.g., the printer 100 in FIG. 1) and the printer information are stored in an associated manner.

The device token table TT is a table storing device tokens. The device token is approval information associated with the printer to be used. The device token is used as approval information when the terminal 200A or 200B uses the printing service, and is also used to designate the printer to be used. In this embodiment, there are two types of users of the printing service, e.g., an administrator and a general user. Also, there are two types of device tokens, e.g., a token for the administrator to be assigned to the administrator, and a token for the general user to be assigned to the general user.

In the device token table TT, device tokens assigned to users are recorded in association with attribute information indicating attributes of the device tokens. The attribute information includes a type of device token, a device ID of the printer associated with the device token, a date and time when the device token was generated, and a status of the device token, as shown in FIG. 2A. The type of device token can be either for the administrator or for the general user, as described above. The device token status is either approved or unapproved. The approved device token is a valid token that can be used when using the printing service. The unapproved device token is an invalid token that cannot be used until it has been approved.

As shown in FIG. 2B, the account management table TBb includes an account table AT, an administrator table MT, and an email address table MAT.

The account table AT is a table in which account information is recorded for each administrator's account. In the present embodiment, as will be described later, the administrator needs to register an account to use the printing service, while the general user can use the printing service without registering an account. For this reason, in the present embodiment, the only accounts registered in the account table AT are those of the administrators.

Each account information includes an account ID, a password, a user name, and a notification token, as shown in FIG. 2B. The notification token is a token used by the server 300 to send push notifications to the terminal device of the account owner (i.e., the administrator). The notification token is approval information assigned to a combination of a terminal device and a terminal application. By performing the push notification using the notification token, a push notification can be sent to the terminal application on the terminal device to which the notification token has been assigned. The push notification is done using a known push notification service such as FCM (short for Firebase Cloud Messaging).

As shown in FIG. 2B, the administrator table MT stores the administrator's account ID and the device ID of the printer in an associated manner. In this way, the administrator's account is associated with the printer. Hereafter, the account associated with a particular printer is also referred to as a corresponding account.

In the email address table MAT, the user's email address is temporarily recorded in the usage starting process described below. In the email address table MAT, email addresses are recorded in association with device IDs, as shown in FIG. 2B.

### (2) USAGE STARTING PROCESS OF PRINTING SERVICE

(A) When Administrator of Printer is Not Available

A user who wishes to receive printing services using the printer 100 transmits a service usage request to one of the servers 300-500 that provides printing services using his or her own terminal device. In the initial state, an administrator of the printer 100 is not available. The service usage request is the initial request for the user to use printing services using the printer 100.

First, a case in which a user of terminal device 200A transmits a service usage request using the terminal device 200A when an administrator is not available will be described. FIGS. 3 and 4 show sequence diagrams of the usage starting process executed when an administrator is not available.

In this example, it is assumed that the user of the terminal device 200A starts the terminal application on the terminal device 200A. The user then designates the printer 100, and inputs a start instruction for the printing service in the terminal application. In this case, for example, the user inputs an IP address of the printer 100 on a well-known input screen and presses a start instruction button.

In S2, in response to the start instruction input by the user, the terminal device 200A transmits a device information request to the printer 100. The device information request is transmitted to a destination which is identified, for example, by the input IP address.

When receiving the device information request, the printer 100 transmits the device information to the terminal device 200A in S4 as a response to the device information request. The device information as transmitted includes the device ID of the printer 100 and the printer information (see FIG. 2A).

When receiving the device information, the terminal device 200A transmits the service usage request to the Web server 500 in S6. In the service usage request, the received device information (i.e., the device ID and the printer information) is included.

When receiving the service usage request, the web server 500 transmits a device administrator check request to the account management server 400 in S8. In the device administrator check request, the received device information (i.e., the device ID and the printer information) is included.

When receiving the device administrator check request, the account management server 400 checks the device administrator in S10. Concretely, the account management server 400 determines whether the device ID included in the device administrator check request is stored in the administrator table MT in association with an account ID. In the present example, as mentioned above, the administrator of the printer 100 is not registered. Therefore, the device ID contained in the device administrator check request is not stored in the administrator table MT.

In response to the device administrator check request, the account management server 40 transmits, in S12, a device administrator absence notification to the web server 500. The device administrator absence notification is a notification that the administrator of the printer 100 is not registered.

When receiving the device administrator absence notification, the web server 500 transmits, in S14, an account information obtaining request to the terminal device 200 in response to the service usage request. When receiving the account information obtaining request, the terminal device 200A displays an account information input screen W1 on the display 250 of the terminal device 200A in S16. In this way, the account information input screen W1 is displayed in response to the account information obtaining request. Therefore, the account information obtaining request can also be called as a request to display the account information input screen W1.

FIGS. 5A-5D show examples of a screen displayed on the terminal device. The account information input screen W1 shown in FIG. 5A includes input fields BX1, BX2 and BX3, and a transmit button BT1. The input field BX1 is a field in which an account ID is to be input. The input field BX2 is a field in which a password is to be input. The input field BX3 is a field in which a user name is to be input.

When the user inputs the account information (e.g., the account ID, the password and the name) on the account information input screen W1 and clicks the transmit button BT1, the terminal device 200A obtains, in S18, the account information via the account information input screen W1.

When obtaining the account information, the terminal device 200A transmits, in S19, an account creation request to the web server 500. The account creation request contains the account information obtained in S18, the notification token, the device information received in S4 and the like. As the terminal device 200A has transmitted a request to a server that provides a known push notification service such as an FCM (firebase count messaging) and obtained the notification token, in advance, from the server.

When receiving the account creation request, the web server 500 transmits the received account creation request to the account management server 400 in S20.

When receiving the account creation request, the account management server 400 creates an account based on the account information contained in the account creation request, that is, the account of the user of the terminal device 200A. Concretely, the account management server 400 records the account information (e.g., the account ID, the password, the name and the like) in association with the notification token in the account table AT (see FIG. 2B).

In S24, the account management server 400 registers the account of the user of the terminal device 200A as created in association with the printer 100. Concretely, the account management server 400 stores the account ID of the user account in the administrator table MT (see FIG. 2B) in association with the device ID contained in the received device information. In this way, the user of the terminal device 200A is registered as the administrator of the printer 100. In the following description, the user of the terminal device 200A is also referred to as the administrator of the printer 100, and the user account of the terminal device 200A may also be referred to as an associated account that is associated with the printer 100.

After registering the associated account, the account management server 400 transmits a token issuance request to the device management server 300 in S26. The token issuance request is a request to issue the device token mentioned above. It is noted that the device information is contained in the token issuance request.

When receiving the toke issuance request, the device management server 300 registers the printer 100 as a management target printer in S27 of FIG. 4. Concretely, the device management server 300 stores the device information (i.e., the device ID and the printer information) in the device table DT (see FIG. 2A).

In S28, the device management server 300 issues an approved device token. Concretely, the device management server 300 creates a device token, and stores the thus created device token in the device token in the device token table TT (see FIG. 2A). The device management server 300 further stores type information indicating the administrator, the device ID contained in the device information, created date and time, and status information indicating that the device token has been approved in the device token table TT in association with the device token.

In S30, the device management server 300 transmits the approved device token as issued to the account management server 400 in response to the token issuance request.

When receiving the approved device token, the account management server 400 transmits an account creation completion notification to the terminal device 200A in S32. The account creation completion notification is transmitted as the push notification with use of the notification token of the terminal device 200, which has been stored in the account table AT.

When receiving the account creation completion notification, the terminal device 200A stores the approved device token contained in the account creation completion notification in the non-volatile storage device 230 in S34. In this way, the usage starting process is terminated.

In the usage starting process described above, the user account of the terminal device 200A is registered in the account management server 400 as the associated account of the printer 100. That is, the user of the terminal device 200A is registered as the administrator of the printer 100. Further, the printer 100 is registered in the device management server 300 as the management target printer. Furthermore, the terminal device 200A obtains the approved device token. As a result, the user of the terminal device 200A is ready to use the printing service using the terminal device 200A (i.e., the terminal device application).

### (B) When Administrator of Printer is Available

Next, a case where the usage starting process is executed when the administrator is available will be described. That is, a case where the user of the terminal device 200B performs the usage request using the terminal device 200B after the usage starting process is performed as the usage process has been performed and the terminal device 200A has been registered as the administrator of the printer 100. FIGS. 6-9 are sequence diagrams showing the usage starting process when the administrator is available.

The user of the terminal device 200B starts, in the terminal device 200B, the terminal application as the user of the terminal device 200A does. The user designates the printer 100 and inputs the start instruction for the printing service in the terminal application.

Processes in S52, S54, S56 and S58 in FIG. 6 are the same as the processes in S2, S4, S6 and S8 in FIG. 3, respectively. Concretely, in S52, the terminal device 200B transmits the device information request to the printer in response to the start instruction. Upon receipt of the device information request, the printer 100 transmits the device information to the terminal device 200B in S54. When receiving the device information, the terminal device 200B transmits the service usage request to the web server 500 in S56. When receiving the service usage request, the web server 500 transmits the device administrator check request to the account management server 400 in S58.

When receiving the device administrator check request, the account management server 400 checks, in S60, whether the device administrator is a registered administrator. Concretely, the account management server 400 determines whether the device ID contained in the device administrator check request is recorded in association with the account ID. In the present example, the user of the terminal device 200B has been registered as the administrator of the printer 100 as mentioned above. That is, the associated account that is associated with the printer 100 has already been registered. Therefore, in the administrator table MT, the device ID contained in the device administrator check request (i.e., the device ID of the printer 100) has been stored in association with the account ID.

In response to the device administrator check request, the account management server 400 transmits, in S62, a device administrator availability notification that represents that the administrator of the printer 100 has been registered to the web server 500, in S62, in response to the device administrator check request.

When receiving the administrator availability notification, the web server 500 transmits a usage application request to the terminal device 200B, in S64, in response to the service usage request. It is noted that the usage application request is different from the account information obtaining request (S14 of FIG. 3) described above. As above, depending whether the administrator of the printer 100 has been registered or not, different requests are transmitted from the web server 500 to the terminal device 200B.

When receiving the usage application request, the terminal device 200B displays a usage application screen W2 on the display 250 of the terminal device 200B in S66. Since the usage application screen W2 is displayed in response to the usage application request, the usage application request can also be referred to as a display request for the usage application screen W2.

The usage application screen W2 includes an input field BX4, a transmission button BT1. The input field BX4 is a field in which an email address is to be input. When the administrator of the printer 100 has been registered, another user (i.e., a general user) is not required to input the account information (e.g., the device ID, the password, the name and the like), but required to input only an email address.

When inputting the email on the usage application screen W2 and clicking the transmit button BT1, the terminal device 200B obtains the email address via the usage application screen W2 in S68.

When obtaining the email address, the terminal device 200B transmits the usage application to the web server 500 in S70. In the usage application, the email address obtained in S68 and the device information received in S54 are included.

When receiving the usage application, the web server 500 transmits the usage application to the account management server 400 in S72.

When receiving the usage application, the account management server 400 stores the email address contained in the usage application in the mail address table MAT (see FIG. 2A) in S73. The email address is associated with the device ID that is contained in the device information obtained in S58.

In S74, the account management server 400 obtains information on the administrator who has already been registered. Concretely, the account management server 400 refers to the administrator table MT and identifies the account ID associated with the device ID contained in the usage application (i.e., the device ID of the administrator). Further, the account management server 400 refers to the account table AT and obtains the user name and the notification token associated with the account ID.

When obtaining the information of the administrator, the account management server 400 transmits a usage approval request to the terminal device 200B in S75 of FIG. 7. The usage approval request is transmitted as the push notification with the use of the notification token of the terminal device 200A that has already been stored in the account table AT. In the usage approval request, the email address obtained in S68 of FIG. 6 (i.e., the email address of the user of the terminal device 200B) is included.

When receiving the usage approval request, the terminal device 200A displays, in S76, an approval/rejection input screen W3 on the display 250 of the terminal device 200A.

The approval/rejection input screen W3 in FIG. 5C includes a message MS1, an email address MA, an approval button BT2, and a disapproval button BT3. The message MS1 is for notifying that the usage application for the printer 100 has been received and prompting the user to enter whether or not to approve the usage application. The approval button BT2 is a UI (user interface) element that is used to input approval of the usage application. The disapproval button BT3 is a UI element that is used to enter that the usage application should not be approved. The email address MA is the mail address of a usage applicant (i.e., the person who made the usage application), in this example, the user of the terminal device 200B. The user of terminal device 200A (the administrator of printer 100), for example, can recognize the usage applicant by looking at the email address MA, and can appropriately determine whether to approve the usage application.

Hereinafter, a case in which the user of the terminal 200A approves the usage application will be described. When the user clicks the approval button BT2 on the approval/rejection input screen W3, the terminal device 200A obtains an input indicating that the usage application is approved in S77.

When receiving the input indicating that the usage application is approved, the terminal device 200A transmits the usage approval notification to the account management server 400 in S78.

When receiving the usage approval notification, the account management server 400 transmits a token-obtaining URL request to the device management server 300 in S80. The token-obtaining URL is a URL that is used by the usage applicant to obtain the device token. In the token-obtaining URL request, the device information received in S58 is contained.

When receiving the token-obtaining URL request, the device management server 300 issues an unapproved device token in S82. Concretely, the device management server 300 creates a device token, and records the device token in the device token table TT (see FIG. 2A). The device management server 300 further records type information indicating that the user is a general user, a device id contained in the device information, created date and time, status information indicating that the device token is unapproved in the device token table TT in association with the device token.

In S84, the device management server 300 creates a URL indicating a location of the issued unapproved device token as the token-obtaining URL. In S86, the device management server 300 transmits the token-obtaining URL to the account management server 400 as a response to the token-obtaining URL request.

When receiving the token-obtaining URL, the account management server 400 transmits the token-obtaining URL to the web server 500 in S88. At this time, the email address of the usage applicant (in this example, the email address of the user of the terminal device 200B) is transmitted to the web server 500, along with the token-obtaining URL.

When receiving the token-obtaining URL and the email address, the web server 500 transmits the token-obtaining URL to the obtained email address in S89. That is, via a well-known email server, an email in which the token-obtaining URL is described is transmitted. In this way, the token-obtaining URL is transmitted to the terminal device 200B. The reason for sending the token-obtaining URL to the email address is to allow the approved usage applicant to obtain the device token because the administrator of the printer 100 has approved the usage application by looking at the email address. For example, if an unapproved usage application is made using another person's email address, it is possible to prevent the person who made the unapproved usage application from obtaining a device token.

When receiving the token-obtaining URL by email, the terminal device 200B displays the token-obtaining URL on the display 250 in response to the user input of browsing instructions for the email in S90. In FIG. 5D, an example of a display screen W4 of the token-obtaining URL is indicated. The display screen W4 shown in FIG. 5D is a screen displaying the email including the token-obtaining URL, and includes a message MS2 and the link URL indicating the token-obtaining URL. The message MS2 is a message notifying that the usage application for the printer 100 has been approved and the device token can be obtained by accessing the token-obtaining URL.

The user my input the token obtaining instruction to the terminal device 200B by, for example, tapping a link LK on the display screen W4. In this way, in S92, the terminal device 220B obtains the token-obtaining instruction.

When obtaining the token-obtaining instruction, the terminal device 200B transmits the token-obtaining request to the device management server 300 in S94 of FIG. 8. In the present embodiment, the token-obtaining request is an HTML (Hypertext Markup Language) request designating the token-obtaining URL associated with the link LK.

When receiving the token-obtaining request, the device management server 300 changes the status of the device token from the unapproved state to the approved state in S96. Concretely, the device management server 300 changes the status of the device token associated with the token-obtaining URL in the device token table TT (see FIG. 2A) from the unapproved status to the approved status.

In S98, the device management server 300 transmits the unapproved device token that associated with the token-obtaining URL to the terminal device 200B in response to the token-obtaining request. For example, the device management server 300 transmits the unapproved device token as an HTML response to the HTML request as the token-obtaining request.

When receiving the approved device token, the terminal device 200B stores the approved device token in the non-volatile storage device 230 in S99. Then, the usage starting process is terminated.

In the usage starting process described above, the terminal device 200B obtains the approved device token without the user account of the terminal device 200B being registered. In this way, as will be described later, the user of the terminal device 200B is in a state where the user can use the printing service using the terminal device 200.

Next, a case where the user of the terminal device 200A does not approve the usage application will be described. FIG. 9 shows a sequence diagram illustrating such a situation. S75 and S76 of FIG. 9 are the same as S75 and S76 of FIG. 7 described above. When the user of the terminal device 200A does not approve the usage application, S77B-S90B are executed instead of S77-S92 of FIG. 7 or S94-S99 of FIG. 8.

When the user clicks the disapproval button BT3 on the approval/rejection input screen W3 (see FIG. 5C), the terminal device 200A obtains an input representing that the usage application is not approved (i.e., disapproved) in S77B.

When obtaining the input representing the disapproval, the terminal device 200A transmits a usage application disapproved notification to the account management server 400 in S78B.

When receiving the usage application disapproved notification, the account management server 400 transmits an unavailability notification to the web server 500 in S88B. At this time, together with the unavailability notification, the email address of the usage applicant (in the present embodiment, the email address of the user of the terminal device 200B) is transmitted to the web server 500.

When receiving the unavailability notification and the email address, the web server 500 transmits the unavailability notification to the email address in S89B. In other words, an email describing the unavailability notification is transmitted via a not shown mail server. In this way, the unavailability notification is transmitted to the terminal device 200B.

When receiving the unavailability notification by email, the terminal device 200B displays the unavailability notification on the display 250 in response to the user input of the email browsing instruction in S90B. Although a display screen showing the unavailability notification is omitted for brevity, such a display screen may include a message notifying that the usage application has not been approved and the printing service cannot be used. In such a case, the terminal device 200B is unable to obtain the approved device token. Therefore, the user of the terminal device 200B cannot use the printing service.

### (3) PRINTING SERVICE

Next, the printing services provided to the terminal devices 200A and 200B after obtaining the device tokens will be described. FIGS. 10A and 10B are sequence diagrams illustrating the printing service.

(A) Printing

Both the user of terminal device 200A (i.e., the administrator) who has obtained a device token for an administrator and the user of terminal device 200B (i.e., the general user) who has obtained a device token for a general user can use the printing service to have the printer 100 perform printing. In the description below, a case in which the user of the terminal device 200B performs printing will be described as an example, but the user of the terminal device 200A can also perform printing in the same way.

When the user of the terminal device 200B starts a terminal application, the terminal device 200B (i.e., the terminal application) displays the print instruction input screen (not shown) on the display 250 of the terminal device 200B in S102. The user can designate an image file representing an image to be printed via the print instruction input screen, thereby inputting the print instruction. The image file is, for example, designated from among files stored in the non-volatile storage device 230.

In response to the user input, the terminal device 200B obtains the print instruction containing the designation of the image file in S104. When obtaining the print instruction, the terminal device 200B transmits a print request to the web server 500 in S106. In the print instruction, the designated image file and the approved device token obtained in the usage starting process described above are included.

When receiving the print request, the web server 500 transmits the print request to the device management server 300 in S108.

When receiving the print request, the device management server 300 executes a token checking process in S110. In the token checking process, the device management server 300 checks whether the device token contained in the print request has been recorded in the device token table TT (see FIG. 2A). When the device token is recorded in the device token table TT, the device management server 30 identifies a destination printer (i.e., the printer 100 in this embodiment) to which a print job is to be transmitted by obtaining the device ID associated with the device token in the device token table. Although not shown in the drawings, when the device token contained in the print request is not recorded in the device token table TT, an error notification is transmitted from the device management server 300 to the terminal device vial the web server 500, and the process is terminated.

In S112, the device management server 300 creates a print job using the image file contained in the print request. Concretely, rasterization, color conversion, and halftone processing are performed on the image data contained in the image file to generate the print data. A print job including the print data and print control data indicating print settings and the like, is generated.

In S114, the device management server 300 transmits the print job to the printer 100. The print job is transmitted in accordance with a well-known method. For example, the device management server 300 may establish a constant connection with the printer 100 in advance according to an XMPP (eXtensible Messaging and Presence Protocol) connection, and transmit print job notifications to the printer 100 using the XMPP connection. The printer 100 may transmit a print job transmission request to the device management server 300 in response to the print job notification, and the device management server 300 may transmit the print job as a response to the transmission request.

When receiving the print job, the printer 100 executes printing based on the received print job in S116. In this way, images represented by the image file that is designated by the user are printed by the printer 100. Using the printing service, the terminal device 200B can cause the printer 100 to print the images without performing a process of generating a print job based on image files. Therefore, even if a printer driver is not installed in the terminal device 200A, the terminal device 200A is capable of causing the printer 100 to print images.

(B) Setting Chang

The user (i.e., the administrator of the terminal device 200A) obtained the device token of the administrator is allowed to perform change of setting regarding the printing service. The user (i.e., the general user) obtained the device token for a general user is not allowed to change the setting regarding the printing service.

When a user of the terminal device 200A starts the terminal application and inputs an instruction to display an input screen for changing settings, the terminal device 200A (terminal application) displays the setting change instruction input screen (not shown) on the display 250 of the terminal device 200A in S152. The user can enter predetermined setting change instructions regarding the printing service via the setting change instruction input screen. The setting change instruction includes, for example, setting or changing of an upper limit of the count of printing sheets per day for one user, restriction of available print modes (e.g., a monochrome mode, a color mode, a high-resolution mode, and the like) per user, and the like.

In response to the user input, the terminal device 200A obtains the setting change instruction in S154. After obtaining the setting change instruction, the terminal device 200A transmits a setting change request to the web server 500 in S156. In the setting change request, the device token for the administrator, which has already been obtained in the usage starting process described above, will be included.

When receiving the setting change request, the web server 500 transmits the setting change request to the device management server 300 in S158.

When receiving the setting change request, the device management server 300 executes the token checking process in S160. In the token checking process, the device management server 300 checks whether the device token included in the setting change request has been recorded in the device token table TT (FIG. 2A). When the device token is recorded, the device management server 300 checks whether the type information associated with the device token in the device token table TT indicates the “administrator” or not. When the type information associated with the device token in the device token table TT indicates the “administrator,” the device management server 300 proceeds to S112. By obtaining the device ID, the device management server 300 identifies the destination printer to which the print job is to be transmitted (i.e., the printer 100 in this example). Although not shown in the drawings, when the device token included in the print request is not recorded in the device token table TT, or when the type information associated with the device token indicates the “general,” an error notification is transmitted from the device management server 300 to the terminal device via the web server 500, and the process is aborted.

In S162, the device management server 300 executes the setting change according to the setting change instruction. For example, in the non-volatile storage device 330 of the device management server 300, a setting file, not shown in the drawing, is stored in association with the device ID, and the device management server 300 may be configured to modify the setting information recorded in the setting file.

According to the embodiment described above, the web server 500 obtains the service usage request (S6 in FIG. 3) based on the user input. The web server 500 obtains the device ID, which is the identification information that identifies the printer 100 (S6 in FIG. 3). When the associated account associated with the device ID is not registered (when there is no administrator shown in FIG. 3 or FIG. 4), the Web server 500 displays an account information input screen for inputting account information in response to the service usage request (S14 in FIG. 3). Concretely, the web server 500 transmits the account information obtaining request to the terminal 200A in order to display the account information input screen W1 on the terminal device 200A. When the associated account is registered (when the administrator in FIG. 6 to FIG. 9 exists), the web server 500 does not execute the process of displaying the account information input screen W1. That is, in this case, the web server 500 does not transmit the account information obtaining request to the terminal device 200A. When no associated account is registered (when the administrator in FIG. 3 or FIG. 4 is not available), the account management server 400 registers the account based on the account information entered in the account information input screen W1 as the associated account with the device ID (S24 in FIG. 3, administrator table MT in FIG. 2B).

As a result, the associated account can be registered appropriately depending on the service usage request for the printing service using the printer 100. For example, unnecessary display of the account information input screen W1 or unnecessary registration of the associated account can be prevented. If more accounts are to be registered even though an administrator's associated account has already been registered, it may be necessary to manage an excessive amount of account information, which could place a heavy burden on the printing service provider. In addition, in view of the management burden on the service provider, it is preferable that the number of accounts to be managed is small, since account information includes personal information.

Furthermore, according to the present embodiment, the account management server 400 creates a new account based on the account information entered in the account information input screen W1 (S22 in FIG. 3) when no associated account has been registered (when there is no administrator as shown in FIGS. 3 and 4), and registers the new account as an associated account (S24 in FIG. 3). As a result, new accounts can be registered as associated accounts. Thus, even a user without an account can use the printing service as an administrator of the printer 100, for example, as a new account is registered.

Furthermore, according to the present embodiment, when no associated account is registered (i.e., when there is no administrator in FIG. 3 and FIG. 4), the device management server 300 and the account management server 400 transmit a device token to the terminal device 200A for the user to use the printing service (S26 in FIGS. 3 to S32 in FIG. 4) in response to the registration of the associated account (S24 in FIG. 3). Then, when the associated account is registered (when the administrator in FIG. 6 to FIG. 9 exists), the device management server 300 and account management server 400 transmit the device token to the terminal device 200B without registering the associated account (S80-S98 in FIG. 7). As a result, unnecessary registration of associated accounts can be prevented, thus the burden of managing accounts can be reduced. Furthermore, general users can use the printing service with a terminal device without having to register an associated account, which improves user convenience. Furthermore, since printing services can be used without entering personal information, the hurdle for using printing services can be lowered and the number of users can be increased.

Further, according to the present embodiment, when the associated account has been registered (i.e., when an administrator in FIGS. 6-9 exists), the account management server 400 an approval request for the user of the terminal device 200B using the printing service to a destination associated with the associated account, which is the terminal device 200A of the administrator (S75 of FIG. 7) using the notification token (FIG. 2B) contained in the account information of the associated account. When a response indicating the approval in response to the approval request is received (S78 in FIG. 7), the device management server 300 and the account management server 400 transmit the device token to the terminal device 200B (S80 in FIGS. 7 to S98 in FIG. 8). In such a case, the owner of the associated account (concretely, the user of terminal device 200A, who is the administrator) transmits the device token when the user of the terminal device 200B is approved to use the printing service so that the owner of the associated account (i.e., the administrator) can be prevented from being disadvantaged. Concretely, it is possible to suppress the problem of device tokens being sent to users that the administrator does not intend (e.g., users that the administrator does not know or users that the administrator wants to deny the use of the printing service), and the printing service being used such users.

Further, according to the present embodiment, the web server 500 performs a displaying process (S64 of FIG. 6) to display the usage application screen W2 to input the user information when the associated account has been registered (i.e., when an administrator in FIGS. 6-9 exists). Concretely, in order to display the usage application screen W2 on the terminal device 200B, the Web server 500 transmits a usage application request to the terminal device 200B. The user information to be obtained is information that is different from the account information but is information about the user of the terminal device 200B, and in the present embodiment, it is an email address. In the usage approval request (S75 in FIG. 7) transmitted to the terminal device 200A, the user information is included. As a result, by including user information in the approval request, the owner (administrator) of the corresponding account (associated account) can appropriately determine whether or not to approve the request. For example, if the email address included in the approval request is an unknown address, or if the email address is that of a person whose use should be denied, the administrator may disapprove the use of the email address.

Further, according to the present embodiment, the device management server 3000, general user to the terminal device 200B using the email address (S88, S89 of FIG. 7, S98 of FIG. 8). As a result, the device token is transmitted to the terminal device 200B of the general user appropriately.

In the present embodiment, a token-obtaining URL is transmitted to the terminal device 200B by transmitting a token-obtaining URL to an email address (S89 in FIG. 7), and a device token is transmitted from the device management server 300 to the terminal device 200B in response to accessing the token-obtaining URL from the terminal device 200B (S98 in FIG. 8). In this way, since the device token is transmitted after checking by the owner of the email address, it is possible to suppress that the device token is inappropriately obtained, for example, by using someone else's email address.

In the present embodiment, as described above, the user information to be included in the usage application is an email address. Since email addresses are widely used, the general user can easily make a usage application using the email address. As a result, the number of users of the printing service can be increased. Furthermore, the administrator can use the email address to appropriately determine whether to approve or deny the usage application. Furthermore, general users can easily obtain device tokens for general users using terminal device 200B simply by including their email address in the usage application.

In the present embodiment, the device token includes two types of device tokens: one for the administrator and one for the general user (FIG. 2A). The device management server 300 and the account management server 400 transmit a device token for the administrator to the terminal device 200A (S26 in FIGS. 3 to S32 in FIG. 4) when no associated account is registered (when there is no administrator in FIG. 3 and FIG. 4) and an associated account is not registered (when there is no administrator in FIG. 3 and FIG. 4). Furthermore, when an associated account is registered (when the administrator shown in FIG. 6 to FIG. 9 exists), the device token for a general user is sent to terminal device 200B (FIG. 6 to FIG. 9). Functions that can be used with the administrator's device token include a function to print (FIG. 10A) and a function to change settings (FIG. 10B). Functions that can be used with device tokens for general users include the function to print (FIG. 10A), but not the function to change settings (FIG. 10B). As a result, it is possible to differentiate the functions available to the administrator, who is the owner of the associated account, from the general user, who is different from the administrator. As a result, the printing service can be operated smoothly.

In the present embodiment, the account management server 400 has a storage (concretely, a non-volatile storage device 430) that stores the administrator table MT, which records the device ID and the account information in an associated manner. The account management server 400 determines whether or not the associated account is registered by determining whether or not the device ID received from the terminal device 200A is recorded in the administrator table MT (S10 in FIGS. 3 and S60 in FIG. 6). As a result, the account management server 400 can easily determine whether or not an associated account is registered based on the device ID received from the terminal devices 200A and 200B.

As can be understood from the above description, the entirety of servers 300, 400, and 500 in the present embodiment is an example of a server and a processing device. The account information input screen W1 is an example of a first input screen, and the usage application screen W2 is an example of a second input screen. The ability to print a print service is an example of a first function, and the ability to configure print settings is an example of a second function. The device token for administrators is an example of a first type token, and the device token for general users is an example of a second type token.

### (3) MODIFICATIONS

In the above embodiment, a service usage request is sent to the Web server 500 and the account management server 400, and the request to display the account information input screen W1 or the usage application screen W2 (i.e., the account information obtaining request and the usage application request) is executed by the account management server 400.

Instead, the terminal devices 200A and 200B (i.e., the terminal application) may determine whether to display the account information input screen W1 or the usage application screen W2, and display the account information input screen W1 and/or the usage application screen W2 according to this determination. In such a case, the terminal devices 200A and 200B may be configured to receive the administrator table MT from the account management server 400 and determine whether the associated account is registered or not by determining whether or not the device ID of the printer 100 has been recorded in the administrator table MT.

Alternatively, by receiving a notification from the account management server 400 that an associated account has been registered, the printer 100 may record information indicating whether or not the associated account has been registered (e.g., a registered flag). In such a case, the terminal devices 200A and 200B may determine whether or not the associated account has been registered by inquiring with the printer 100 and receiving information (a registered notice or flag) from the printer 100 indicating whether or not the associated account has been registered. Terminals 200A and 200B display the account information input screen W1 when it is determined that the associated account has not been registered, while display the usage application screen W2 when it is determined that the associated account has been registered. When it is determined that the associated account has not been registered, the terminal devices 200A and 200B cause the account management server 400 to register the associated account by transmitting the registration request containing the account information and the device information to the account management server 400.

Thus, the obtaining of the service usage request based on user input, the obtaining of the device ID, the determination of which of the account information input screen W1 and the usage application screen W2 to display, and the registration of the associated account may all be performed by the terminal application of terminal devices 200A and 200B. W2. In this modification, the terminal devices 200A and 200B are examples of an information processing device.

In the above embodiment, if no associated account is registered, a new account is created, and the new account is registered with the account management server 400 as an associated account. Alternatively, the account information (account ID and password) of an existing account may be obtained via the account information input screen W1, and the existing account may be registered with the account management server 400 as an associated account. As an existing account, for example, an account for an existing web service different from the printing service (e.g., an account for GOOGLE (registered trademark), APPLE (registered trademark), and the like) could be employed. In such a case, the account management server 400 uses the information on an existing account obtained via the account information input screen W1 to access the server providing the existing WEB service server, and registers the existing account as an associated account after confirming the existence of the existing account.

In the above embodiment, the web server 500 obtains the service usage request based on the user's input from the terminal devices 200A and 200B. Alternatively, a service usage request and device ID may be transmitted from the printer 100 to the account management server 400, for example, in response to each user's input of transmission instructions to the printer 100. In such a case, the account information input screen W1 and the usage application screen W2 may be displayed on the display 140 of the printer 100 in response to instructions from the account management server 400. Alternatively, a QR code (registered trademark of DENSO WAVE INCORPORATED) indicating a request to display the account information input screen W1 or the usage application screen W2 may be displayed on the display 140 of the printer 100 in response to instructions from the account management server 400. In such a case, by reading the QR code using the user's terminal device (200A or 200B), the account information input screen W1 or the usage application screen W2 is displayed on the user's terminal device.

In the above embodiment, when the associated account has already been registered, the usage application screen W2 is displayed on the terminal device 200B, and the usage application is transmitted from the terminal device 200B to the web server 500. Alternatively, the web server 500 may notify the terminal device 200 that the printing service is not available when the associated account has already been registered. In such a case, a message indicating that use of the printing service is not permitted is displayed on the display 250 of the terminal device 200B. In such a case, the user of the terminal device 200B cannot use the printing service.

In the above embodiment, when a usage application is made, a usage approval request is transmitted to the administrator's terminal device 200A, and when the administrator approves the usage, a device token for a general user is transmitted to the user's terminal device 200B. Alternatively, when a usage application is made, a device token for a general user may be transmitted to the user's terminal device 200B without a usage approval request being transmitted to the administrator's terminal device 200A. In such a case, a device token for a general user may be transmitted to any user, or a device token for a general user may be transmitted only to users who have made a usage application using an email address recorded in a list registered by the administrator in advance.

In the above embodiment, the information of the user who made the usage application, which is included in the usage approval request, is the email address. Not only this, the user information included in the usage approval request may be other information such as a name of the user who made the usage application, employee ID, and the like.

In the above embodiment, the device token for the general user is transmitted to the terminal device 200B by transmitting a token-obtaining URL to the email address entered on the usage application screen W2. Alternatively, a device token for general users may be transmitted to the terminal device 200B by other means, e.g., push notification to the terminal device 200B, attachment to an email, and the like.

In the above embodiment, two types of device tokens are used, one for administrators and the other for general users. Alternatively, only one type of device token may be used. In such a case, there may be no difference in the functions available to the administrator and the general user.

The above embodiment describes a case in which a service usage request for the printing service provided using the printer 100 is transmitted from a terminal device. Service usage requests for services using other devices, not limited the printing service, may also be transmitted from the terminal device. As for services using other devices, services that remotely operate other devices (e.g., surveillance cameras, appliances such as cooking utensils, and the like) set up in the home or office using a terminal device (terminal application) could be employed.

In the above embodiment, the three servers 300, 400, and 500 cooperate to communicate with the terminal devices 200A and 200B, generate and transmit device tokens, and register associated accounts. Alternatively, the processes performed by the three servers 300, 400, and 500 may be performed by a single server. Furthermore, the processing performed by the web server 500 may be performed by either the device management server 300 or the account management server 400, thereby the processes performed by the three servers 300, 400 and 500 in the above embodiment may be performed by the two servers 300 and 400 in the modification.

Part of the configuration realized by hardware in the above embodiment may be replaced with software, or conversely, part or all of the configuration realized by software may be replaced with hardware.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An information processing device, comprising a controller,
wherein the controller is configured to perform:
obtaining a usage request based on an input from a user, the usage request being a request of the user to use a service using a particular device;
obtaining device identification information identifying the particular device;
first obtaining including:
displaying, according to the usage request, a first input screen where account information is to be input when an associated account associated with the device identification information is not registered; and
not displaying the first input screen when the associated account is registered; and
registering the associated account in association with the device identification information based on the account information input on the first input screen when the associated account is not registered.

2. The information processing device according to claim 1,
wherein, when the associated account is not registered, the controller is configured to, in the registering, creating a new account based on the account information input on the first input screen and registering the new account in association with the device identification information.

3. The information processing device according to claim 1,
wherein the information processing device is a server configured to communicate with at least one of a terminal device of the user and the particular device;
wherein the controller is further configured to perform:
obtaining the usage request from the at least one of the terminal device of the user and the particular device;
obtaining the device identification information from the at least one of the terminal device of the user and the particular device; and
in the first obtaining, transmitting, to the at least one of the terminal device of the user and the particular device, information used to display the first input screen, and
wherein the first input screen is displayed on a display of the at least one of the terminal device of the user and the particular device.

4. The information processing device according to claim 3,
wherein the controller is configured to perform:
transmitting a token used to use the service to the terminal device in response to registering the associated account when the associated account is not registered; and
transmitting the token to the terminal device without registering the associated account when the associated account is registered.

5. The information processing device according to claim 4,
wherein the controller is configured to perform:
transmitting an approval request for the user to use the service to a destination associated to the associated account based on account information of the associated account when the associated account is registered; and
transmitting the token to the terminal device when receiving a response indicating approval of the approval request.

6. The information processing device according to claim 5,
wherein the controller is configured to perform, when the associated account is registered, second displaying of displaying a second input screen where user information is to be input,
wherein the user information is information different from the account information, the user information being information related to the user, and
wherein the approval request includes the user information input on the second input screen.

7. The information processing device according to claim 6,
wherein the controller is configured to perform transmitting the token to the terminal device based on the user information.

8. The information processing device according to claim 6,
wherein the user information is an email address.

9. The information processing device according to claim 6,
wherein the token includes a first type token and a second type token,
wherein the controller is configured to perform:
transmitting the first token to the terminal device when the associated account is not registered; and
transmitting the second token to the terminal device when the associated account is registered,
wherein a function that can be used with the first token includes a first function and a second function, and
wherein a function that can be used with the second token includes the first function and does not include the second function.

10. The information processing device according to claim 3, further comprising a storage,
wherein the controller is further configured to perform:
accommodating a table in which the device identification information and the account information are recorded in an associated manner in the storage;
determining whether the associated account is registered by determining whether the device information received from the terminal device is recorded in the table.

11. A non-transitory computer-readable storage medium for an information processing device having a controller, the non-transitory computer-readable storage medium containing computer-executable instructions which cause, when executed by the controller, the information processing device to perform:
obtaining a usage request based on an input from a user, the usage request being a request of the user to use a service using a particular device;
obtaining device identification information identifying the particular device;
first obtaining including:
displaying, according to the usage request, a first input screen where account information is to be input when an associated account associated with the device identification information is not registered; and
not displaying the first input screen when the associated account is registered; and
registering the associated account in association with the device identification information based on the account information input on the first input screen when the associated account is not registered.
